(19) United States
(12) Patent Application Publication
(10) Pub. No.: US 2006/0047462 A1
(43) Pub. Date: Mar. 2, 2006

(54) Displacement estimation system and method

(76) Inventors: Carl E. Picciotto, Menlo Park, CA (US); Jun Gao, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/931,005

(22) Filed: Aug. 31, 2004

(51) Int. Cl. G06F 19/00

(52) U.S. Cl. 702/120

(57) ABSTRACT

A displacement estimation system comprising a data acquisition system and a processing system is provided. The data acquisition system is configured to capture a first frame from a first substrate including a first pattern at a first time and capture a second frame from a second substrate including a second pattern at a second time subsequent to the first time. The first pattern and the second pattern are substantially identical. The processing system is configured to calculate a displacement between the first pattern and the second pattern using the first frame and the second frame.

### CROSS-REFERENCE TO RELATED APPLICATIONS

This application is related to U.S. patent application Ser. No. ______, Docket No. 200403527-1, filed concurrently herewith, entitled DISPLACEMENT ESTIMATION SYSTEM AND METHOD and U.S. patent application Ser. No. ______, Docket No. 200403695-1, filed concurrently herewith, entitled DISPLACEMENT ESTIMATION SYSTEM AND METHOD. Each of the above U.S. patent applications is assigned to the assignee of the present invention, and is hereby incorporated by reference herein.

### BACKGROUND

Various systems exist for the purpose of positioning one or more substrates in one or more locations to allow operations to be performed on the substrate or substrates. Some systems, such as alignment systems, attempt to position substrates by directly aligning one or more patterns on the substrates with the goal of a zero-length displacement. Moiré patterns or other particular patterns such as a box and a cross may be used for this purpose. However, the use of such patterns, particularly with respect to the precision gratings required to produce moiré or diffraction patterns, may add costs to the manufacturing process.

With existing alignment systems, the positioning of substrates may be poorly quantized and may not be useful in instances where a non-zero displacement is desired. Further, due to process variations, alignment systems that compare patterns across different substrates may run into performance limitations. It would be desirable to be able to accurately quantize the position or positions of substrates.

### SUMMARY

One form of the present invention provides a displacement estimation system comprising a data acquisition system and a processing system. The data acquisition system is configured to capture a first frame from a first substrate including a first pattern at a first time and capture a second frame from a second substrate including a second pattern at a second time subsequent to the first time. The first pattern and the second pattern are substantially identical. The processing system is configured to calculate a displacement between the first pattern and the second pattern using the first frame and the second frame.

### BRIEF DESCRIPTION OF THE DRAWINGS

FIG. 1 is a block diagram illustrating a displacement estimation system according to one embodiment of the present invention.

FIG. 2 is a flow chart illustrating a method for calculating a displacement according to one embodiment of the present invention.

FIG. 3A is a block diagram illustrating a substrate with a pattern in an image frame at a first time according to one embodiment of the present invention.

FIG. 3B is a block diagram illustrating a substrate with a pattern in an image frame at a second time according to one embodiment of the present invention.

FIG. 3C is a block diagram illustrating locations of the substrate at different times in an image frame according to one embodiment of the present invention.

FIG. 4 is a block diagram illustrating a displacement adjustment system according to one embodiment of the present invention.

FIG. 5 is a flow chart illustrating a method for calculating and using a displacement according to one embodiment of the present invention.

FIG. 6 is a block diagram illustrating a displacement adjustment system according to one embodiment of the present invention.

FIG. 7 is a flow chart illustrating a method for calculating and using a displacement according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

A system and method for determining the relative positioning between a substrate that includes a pattern at different times through the use of image displacement calculations are provided. The image displacement calculations involve the process of identifying a location of the pattern in a reference frame captured at a first time, identifying a location of the pattern in a comparison frame captured at a second time that is subsequent to the first time, and estimating the distance between the pattern locations to calculate a displacement. The displacement may be used to move a substrate into an exacting relative position or may be used to move a functional unit, such as a piece of fabrication equipment, relative to the substrate.

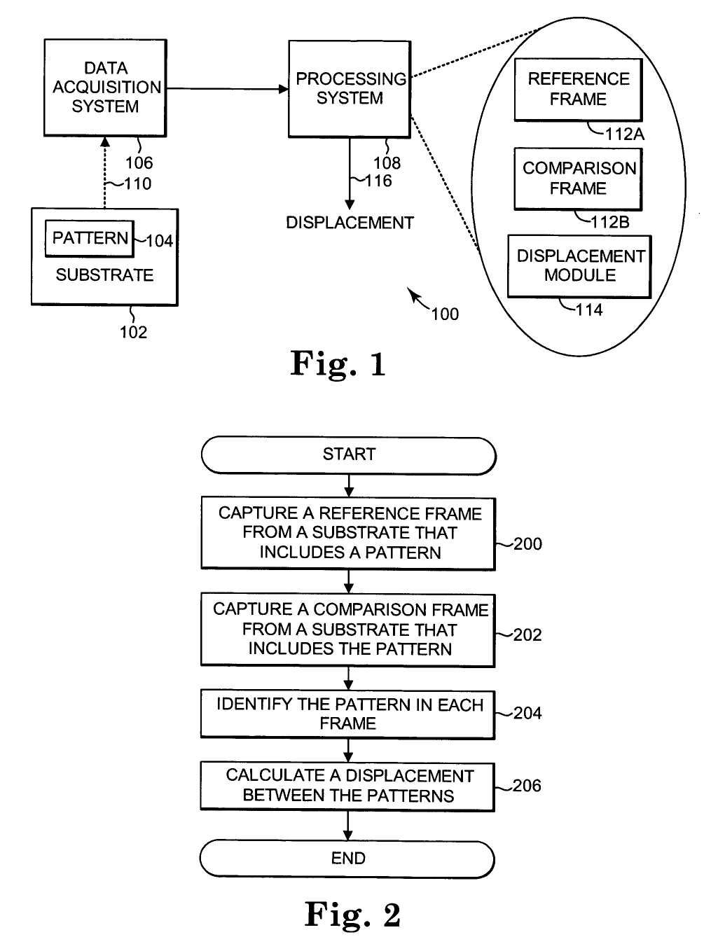

FIG. 1 is a block diagram illustrating one embodiment of a displacement estimation system 100. Displacement estimation system 100 comprises a substrate 102, a data acquisition system 106, and a processing system 108.

Substrate 102 includes a pattern 104. Substrate 102 may be any suitable one, two, or three dimensional work object such as a silicon or other type of semiconductor wafer, paper, and a web of material. The term “web of material” covers both a web of material that carries objects (e.g., a conveyor) and the surface of a work object that is moveable relative to displacement estimation system 100.

Pattern 104 comprises any feature or set of features that is man-made or naturally occurring on substrate 102. Man-made features include alignment marks formed on substrate 102, features formed on substrate 102 as part of a manufacturing process associated with substrate 102, and features formed on substrate 102 prior to a manufacturing process associated with substrate 102. Naturally occurring features include features of the substrate itself, e.g., paper fibers in paper, and contaminants on or within the substrate, e.g., dust on the surface of a semiconductor wafer. Pattern 104 may include broad-area features of substrate 102, whether the features cover a large or small area of substrate 102. Pattern 104 may be readily visible or visible only in response to an applied illumination field.

Data acquisition system 106 comprises any suitable optical or non-optical system configured to acquire data from substrate 102 at a first time to form reference frame 112A and acquire data from substrate 102 at a second time to form comparison frame 112B. Between the first time and the second time, substrate 102 may be moved within system 100, e.g., moved relative to data acquisition system 106, or removed from system 100 entirely and replaced in system 100. Accordingly, substrate 102 may be in different locations within system 100 at the first and second times. Frames 112A and 112B are used to identify the relative locations of pattern 104 at the first time and the second time, respectively, with reference to system 100. Examples of optical systems include one or more cameras or other devices configured to optically capture image 112. Examples of non-optical systems include electron beam devices or other devices configured to capture image 112 using non-optical means.

Data acquisition system 106 has a resolution and a scale appropriate for the type of substrate 102. The resolution may be pixel, sub-pixel, or another suitable resolution, and the scale may be nanoscale or another suitable resolution. Frames 112A and 112B comprise any set of optical or non-optical images that comprise data that may be used to identify the relative locations of pattern 104 at two different times.

In operation, data acquisition system 106 captures reference frame 112A of substrate 102 that includes pattern 104 at a first time as indicated by a dashed arrow 110 and provides reference frame 112A to processing system 108. At a second time, data acquisition system 106 captures comparison frame 112B of substrate 102 that includes pattern 104 as indicated by dashed arrow 110 and provides comparison frame 112B to processing system 108. As noted above, substrate 102 may be moved within system 100 or removed from system 100 and replaced in system 100 between the first time and the second time.

Processing system 108 receives and stores frames 112A and 112B, and processes frames 112A and 112B using a displacement module 114. Using displacement module 114, processing system 108 identifies or locates pattern 104 in each of frames 112A and 112B, and calculates a displacement between pattern 104 in reference frame 112A and pattern 104 in comparison frame 112B as indicated by an arrow 116. Processing system 108 identifies or locates pattern 104 by searching for pattern 104 in selected regions of frames 112A and 112B. The regions may be selected from anticipated locations of pattern 104. The regions may be searched using coarse searching algorithms to locate general regions where pattern 104 is located and then using fine searching algorithms to locate the specific regions where pattern 104 is located. Processing system 108 may calculate the displacement to a pixel or a sub-pixel resolution.

Displacement module 114 may embody any suitable algorithm for calculating the displacement between pattern 104 in reference frame 112A and pattern 104 in comparison frame 112B. Suitable algorithms may include an image cross-correlation algorithm, a phase delay detection algorithm, or other displacement estimation algorithms.

With the image cross-correlation algorithm, displacement module 114 uses image cross-correlations to calculate the displacement. One example of an image cross-correlation algorithm is a nearest neighbor navigation algorithm. With the nearest neighbor navigation algorithm, displacement module 114 uses image cross-correlations or comparison functions which approximate or parallel pixel-by-pixel correlation functions to calculate the displacement. The nearest neighbor navigation algorithm uses very short correlation distances in calculating the displacement. Additional details of nearest neighbor navigation algorithms may be found in U.S. Pat. No. 5,149,980 entitled “SUBSTRATE ADVANCE MEASUREMENT SYSTEM USING CROSS-CORRELATION OF LIGHT SENSOR ARRAY SIGNALS” listing Ertel et al. as inventors and U.S. Pat. No. 6,195,475 entitled “NAVIGATION SYSTEM FOR HANDHELD SCANNER” listing Beausoleil et al. as inventors. Each of these patents is assigned to the assignee of the present invention, and is hereby incorporated by reference herein.

With the phase delay detection algorithm (and other similar phase correlation methods), displacement module 114 processes images converted to a frequency domain representation and draws equivalences between phase delays and displacements to calculate the displacement.

In certain embodiments, displacement module 114 may calculate one or more geometric extractions, such as a centerline, from pattern 104 in embodiments where pattern 104 is a geometric pattern. In these embodiments, displacement module 114 calculates the displacement using the one or more geometric extractions.

Functions performed by processing system 108 and/or displacement module 114 may be implemented in hardware, software, firmware, or any combination thereof. The implementation may be via a microprocessor, programmable logic device, or state machine. Components of the present invention, e.g., displacement module 114, may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

FIG. 2 is one embodiment of a flow chart illustrating a method for calculating a displacement. The method shown in FIG. 2 may be implemented by displacement estimation system 100. Referring to FIGS. 1 and 2, data acquisition system 106 captures reference frame 112A from substrate 102 that includes pattern 104 at a first time as indicated in a block 200. Data acquisition system 106 captures comparison frame 112B from substrate 102 that includes pattern 104 as indicated in a block 202. Displacement module 114 identifies pattern 104 in each frame 112A and 112B as indicated in a block 204. Displacement module 114 calculates a displacement between pattern 104 in reference frame 112A and pattern 104 in comparison frame 112B as indicated in a block 206.

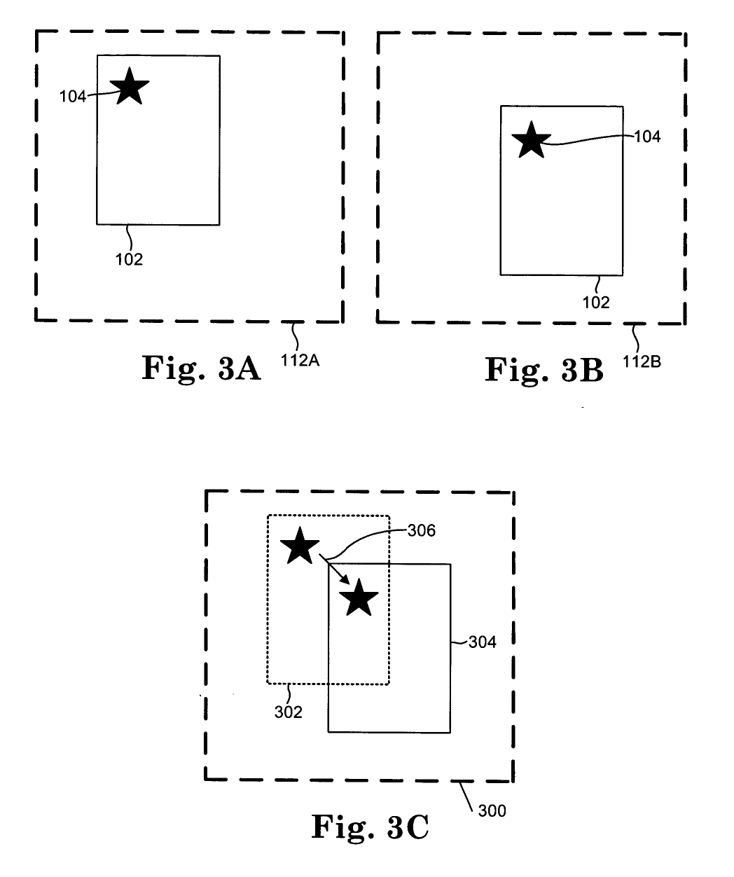

FIGS. 3A-3C are block diagrams illustrating one embodiment of capturing frames 112A and 112B that include substrate 102 with pattern 104. In FIG. 3A, reference frame 112A includes substrate 102 with pattern 104 at a first location at a first time. Subsequent to the first time and prior to a second time, substrate 102 is either moved within system 100 or removed from system 100 and replaced in system 100. In FIG. 3B, comparison frame 112B includes substrate 102 with pattern 104 at a second location at a second time.

FIG. 3C is a block diagram illustrating the locations of substrate 102 at the first time and the second time in an image frame 300. Image frame 300 encompasses the same area as reference frame 112A and comparison frame 112B. The location of substrate 102 and pattern 104 at the first time is indicated by the dashed-line box 302, and the location of substrate 102 and pattern 104 at the second time is indicated by the solid-line box 304. By identifying pattern 104 in each frame 112A and 112B, processing system 108 calculates a displacement between the patterns 104 as indicated by an arrow 306.

Although shown in FIGS. 3A-3C as encompassing the entirety of substrate 102, reference frame 112A and comparison frame 112B may encompass only a portion of substrate 102 that includes pattern 104 in other embodiments. In addition, the displacement of substrate 102 at the first and second times may be relatively small such that the location of substrate 102 at the first time would overlap the location of substrate 102 at the second time from the perspective of data acquisition system 106. The displacement may also be relatively large such that the location of substrate 102 at the first time would not overlap the location of substrate 102 at the second time from the perspective of data acquisition system 106.

In other embodiments, substrate 102 may include one or more additional patterns. Data acquisition system 106 may capture these additional patterns in reference frame 112A and comparison frame 112B, and processing system 108 may calculate a displacement between each additional pattern of substrate 102 in these embodiments. The additional patterns may be used to sense rotational alignment of substrate 102 at different times.

Although substrate 102 is moved within system 100 or removed from system 100 and replaced in system 100 between the first time and the second time, substrate 102 is preferably in the same focal plane at the first time and the second time to avoid lateral movement uncertainties or magnification variations which may occur when changing focus or moving data acquisition system 106.

Although the above embodiments have been described such that substrate 102 is moved within system 100 or removed from and replaced in system 100, another substrate with a pattern substantially identical to pattern 104 may be placed in system 100 instead of the original substrate 102 at the second time in other embodiments. In these embodiments, reference frame 112A includes one of more images of the original substrate 102 with pattern 104 and comparison frame 112B includes one of more images of the other substrate with the substantially identical pattern. Processing system 108 calculates the displacement between pattern 104 in reference frame 112A and the substantially identical pattern in comparison frame 112B. The substantially identical pattern may be an exact replica of pattern 104 or may vary slightly from pattern 104 due to fabrication or process differences. The level of variation between pattern 104 in substrate 102 and the substantially identical pattern in the other substrate may depend on the resolution or scale of reference frame 112A and comparison frame 112B or on the ability of processing system 108 to recognize the patterns as identical. When the substantially identical pattern is not an exact replica of pattern 104, the displacement calculated by processing system 108 may be offset by an amount that is proportion to the difference between the substantially identical pattern and pattern 104. Such pattern deviations may be tolerated with an offset adjustment calculated by processing system 108.

In other embodiments, data acquisition system 106 may include two or more independent data acquisition systems, e.g., two cameras, located at a fixed distance from one another. In such an embodiment, data acquisition system 106 captures two reference frames and two comparison frames (not shown) such that the pattern appears in at least one of the two reference frames and one of the two comparison frames. Data acquisition system 106 provides the two reference frames and two comparison frames to processing system 108, and processing system 108 identifies the patterns in the frames and calculates the displacement between the patterns according to the fixed distance between cameras.

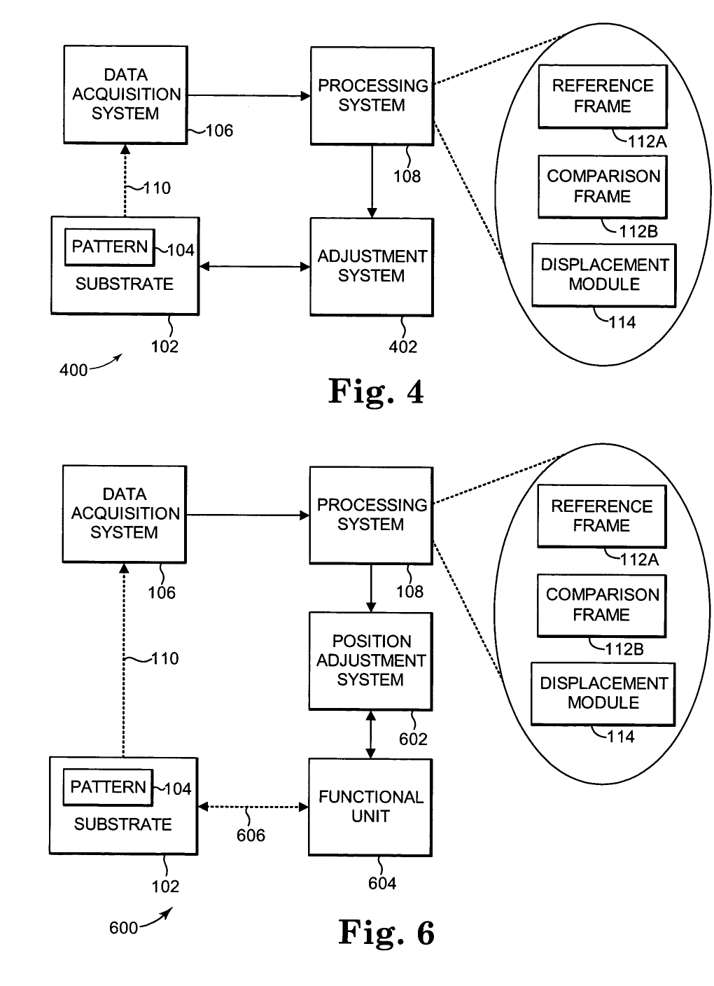

FIG. 4 is one embodiment of a block diagram illustrating a displacement adjustment system 400. Displacement adjustment system 400 comprises substrate 102 that includes pattern 104, data acquisition system 106, processing system 108, and an adjustment system 402. In the embodiment of FIG. 4, adjustment system 402 receives the displacement from processing system 108 and adjusts the position of substrate 102 according to a value of the displacement. The value represents a distance value that indicates a distance between pattern 104 at different times.

FIG. 5 is one embodiment of a flow chart illustrating a method for calculating and using a displacement. The method shown in FIG. 5 may be implemented by displacement adjustment system 400. Referring to FIGS. 4 and 5, data acquisition system 106 captures reference frame 112A from substrate 102 that includes pattern 104 at a first time as indicated in a block 200. Data acquisition system 106 captures comparison frame 112B from substrate 102 that includes pattern 104 as indicated in a block 202. Displacement module 114 identifies pattern 104 in each frame 112A and 112B as indicated in a block 204. Displacement module 114 calculates a displacement between pattern 104 in reference frame 112A and pattern 104 in comparison frame 112B as indicated in a block 206. Adjustment system 402 adjusts the position of substrate 102 using the displacement as indicated in a block 502. A determination is made by processing system 108 as to whether to perform another iteration as indicated in block 504. If another iteration is to be performed, then the functions of blocks 202 through 504 are repeated. If another iteration is not to be performed, then the method ends. In certain embodiments, the function of block 200 may also be repeated in one or more of the iterations.

FIG. 6 is one embodiment of a block diagram illustrating a displacement adjustment system 600. Displacement adjustment system 600 comprises substrate 102 that includes pattern 104, data acquisition system 106, processing system 108, a position adjustment system 602, and at least one functional unit 604. In the embodiment of FIG. 6, position adjustment system 602 receives the displacement from processing system 108 and adjusts the position of functional unit 604 relative to substrate 102 according to the value of the displacement as indicated by a dashed arrow 606. Functional unit 604 may be any system or apparatus configured to perform an operation on substrate 102.

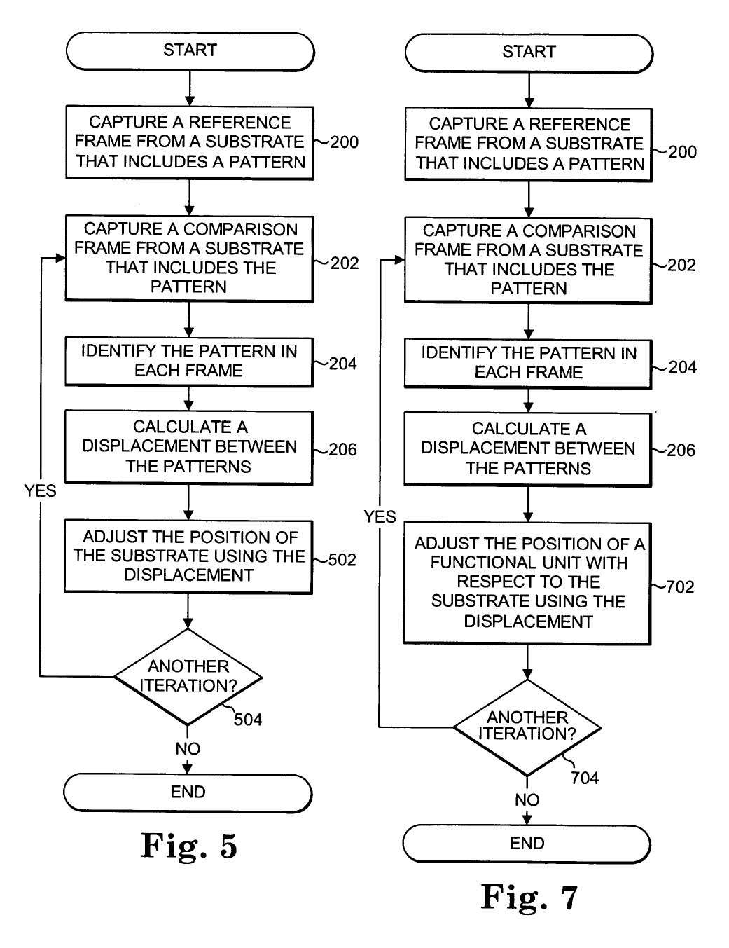

FIG. 7 is one embodiment of a flow chart illustrating a method for calculating and using a displacement. The method shown in FIG. 7 may be implemented by displacement adjustment system 600. Referring to FIGS. 6 and 7, data acquisition system 106 captures reference frame 112A from substrate 102 that includes pattern 104 at a first time as indicated in a block 200. Data acquisition system 106 captures comparison frame 112B from substrate 102 that includes pattern 104 as indicated in a block 202. Displacement module 114 identifies pattern 104 in each frame 112A and 112B as indicated in a block 204. Displacement module 114 calculates a displacement between pattern 104 in reference frame 112A and pattern 104 in comparison frame 112B as indicated in a block 206. Position adjustment system 602 adjusts the position of functional unit 604 with respect to substrate 102 using the displacement as indicated in a block 702. A determination is made by processing system 108 as to whether to perform another iteration as indicated in block 704. If another iteration is to be performed, then the functions of blocks 202 through 704 are repeated. If another iteration is not to be performed, then the method ends. In certain embodiments, the function of block 200 may also be repeated in one or more of the iterations.

In other embodiments, position adjustment system 602 may adjust the position of functional unit 604 with respect to one or more substrates other than substrate 102 using the displacement.

Displacement estimation system 100 and displacement adjustment systems 400 and 600 may be used in a wide variety of applications. The applications include lithography such as optical lithography, imprint or contact lithography, and nanoimprint lithography.

Embodiments described herein may provide advantages over previous alignment systems. For example, substrates may be positioned without the need to overlay patterns on top of each other. In addition, center lines may not need to be calculated. Further, patterns may not need to be symmetric or precisely formed. Still further, the use of costly moiré patterns and diffraction patterns with gratings may be avoided. Also, in embodiments where patterns existing in the substrate are used, space on the substrate may not need to be allocated for alignment marks. Lastly, patterns may be compared against previous images of themselves rather than physically different (though substantially identical) patterns.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A displacement estimation system comprising:
a data acquisition system; and
a processing system;
wherein the data acquisition system is configured to capture a first frame from a first substrate including a first pattern at a first time and capture a second frame from a second substrate including a second pattern at a second time subsequent to the first time, wherein the first pattern and the second pattern are substantially identical, and wherein the processing system is configured to calculate a displacement between the first pattern and the second pattern using the first frame and the second frame.

2. The displacement estimation system of claim 1 wherein the data acquisition system is configured to provide the first frame and the second frame to the processing system, wherein the processing system is configured to identify the first pattern in the first frame, and wherein the processing system is configured to identify the second pattern in the second frame.

3. The displacement estimation system of claim 1 further comprising:
an adjustment system configured to receive the displacement from the processing system;
wherein the adjustment system is configured to adjust a position of the second substrate using the displacement.

4. The displacement estimation system of claim 1 further comprising:
a position adjustment system configured to receive the displacement from the processing system;
wherein the position adjustment system is configured to adjust a position of a functional unit relative to a third substrate using the displacement.

5. The displacement estimation system of claim 4 wherein the third substrate includes the second substrate.

6. The displacement estimation system of claim 1 wherein the first substrate includes the second substrate, and wherein the first pattern includes the second pattern.

7. The displacement estimation system of claim 6 wherein the first substrate is moved relative to the data acquisition system subsequent to the first time and prior to the second time.

8. The displacement estimation system of claim 6 wherein the first substrate is removed from the displacement estimation system entirely subsequent to the first time and replaced in the displacement estimation system prior to the second time.

9. The displacement estimation system of claim 1 wherein the first substrate is removed from the displacement estimation system entirely subsequent to the first time, and wherein the second substrate is placed in the displacement estimation system prior to the second time.

10. The displacement estimation system of claim 1 wherein the first substrate and the second substrate are each selected from the group consisting of a semiconductor wafer, paper, and a web of material.

11. The displacement estimation system of claim 1 wherein the first pattern and the second pattern each comprise a man-made pattern.

12. The displacement estimation system of claim 1 wherein the first pattern naturally occurs on the first substrate, and wherein the second pattern naturally occurs on the second substrate.

13. The displacement estimation system of claim 1 wherein the data acquisition system comprises an optical system.

14. The displacement estimation system of claim 13 wherein the data acquisition system comprises at least one camera.

15. The displacement estimation system of claim 1 wherein the data acquisition system comprises a non-optical system.

16. The displacement estimation system of claim 1 wherein the processing system is configured to calculate the displacement according to a resolution selected from the group consisting of pixel resolution and sub-pixel resolution.

17. A method comprising:
capturing a first frame from a first substrate including a first pattern at a first time;
capturing a second frame from a second substrate including a second pattern that is substantially identical to the first pattern at a second time subsequent to the first time;
identifying the first pattern in the first frame;
identifying the second pattern in the second frame; and
calculating a displacement between the first pattern and the second pattern using the first frame and the second frame.

18. The method of claim 17 further comprising:
adjusting a position of the second substrate using the displacement.

19. The method of claim 18 wherein the second substrate includes the first substrate, and wherein the second pattern includes the first pattern.

20. The method of claim 17 further comprising:
adjusting a position of a functional unit with respect to the second substrate using the displacement.

21. The method of claim 20 wherein the second substrate includes the first substrate, and wherein the second pattern includes the first pattern.

22. The method of claim 17 further comprising:
moving the first substrate subsequent to the first time and prior to the second time.

23. A system comprising:
means for capturing a first frame from a first substrate including a first pattern at a first time;
means for capturing a second frame from a second substrate including a second pattern substantially identical to the first pattern at a second time subsequent to the first time; and
means for calculating a displacement between the first pattern and the second pattern using the first frame and the second frame.

24. The system of claim 23 further comprising:
means for adjusting a position of the second substrate using the displacement.

25. The system of claim 23 further comprising:
means for adjusting a position of a functional unit relative to the second substrate using the displacement.

26. The system of claim 23 wherein the second substrate including the first substrate, and wherein the second pattern including the first pattern.

27. The system of claim 26 wherein the first substrate is moved relative to the means for capturing the first frame subsequent to the first time and prior to the second time.

28. The system of claim 26 wherein the first substrate is removed from the system entirely subsequent to the first time and replaced in the system prior to the second time.

29. The system of claim 23 wherein the first substrate is removed from the system entirely subsequent to the first time, and wherein the second substrate is placed in the system prior to the second time.

30. The system of claim 23 wherein the first frame comprises a reference frame, and wherein the second frame comprises a comparison frame.

31. The system of claim 23 wherein the first substrate and the second substrate are each selected from the group consisting of a semiconductor wafer, paper, and a web of material.

32. The system of claim 23 wherein the first pattern and the second pattern each comprise a man-made pattern.

33. The system of claim 23 wherein the first pattern naturally occurs on the first substrate, and wherein the second pattern naturally occurs on the second substrate.

34. A computer-readable medium having computer-executable instructions for performing a method of calculating a displacement, comprising:
receiving a first frame including a first pattern embodied in a first substrate;
receiving a second frame including a second pattern substantially identical to the first pattern and embodied in a second substrate;
identifying the first pattern in the first frame;
identifying the second pattern in the second frame; and
calculating the displacement between the first pattern and the second pattern using the first frame and the second frame.

35. The computer-readable medium of claim 34 wherein the computer-readable medium has computer-executable instructions for:
providing the displacement to an adjustment system that is configured to adjust a position of the second substrate using the displacement.

36. The computer-readable medium of claim 34 wherein the computer-readable medium has computer-executable instructions for:
providing the displacement to a position adjustment system configured to adjust a position of a functional unit with respect to the second substrate using the displacement.

37. The computer-readable medium of claim 34 wherein first substrate includes the second substrate, and wherein the first pattern includes the second pattern.
